(19) United States
(12) Patent Application Publication
(10) Pub. No.: US 2026/0121844 A1
(43) Pub. Date: Apr. 30, 2026

(54) COMMUNICATION APPARATUS, COMMUNICATION METHOD, AND COMMUNICATION SYSTEM

(71) Applicant: NEC Corporation, Tokyo (JP)

(72) Inventors: Hiroki KAWAHARA, Tokyo (JP); Tetsuo KAWAKAMI, Tokyo (JP)

(73) Assignee: NEC Corporation, Tokyo (JP)

(21) Appl. No.: 19/359,961

(22) Filed: Oct. 16, 2025

(30) Foreign Application Priority Data
Oct. 29, 2024 (JP) 2024-190015

(51) Int. Cl. H04L 9/08; H04B 10/27; H04J 14/02

(52) U.S. Cl. CPC H04L 9/0858; H04B 10/27; H04J 14/02

(57) ABSTRACT

It is an object of the present disclosure to appropriately perform quantum key distribution through an optical wavelength division multiplexing link. There is provided a communication apparatus that communicates an optical signal based on an electrical signal obtained by multiplexing a first control signal addressed to a second optical communication apparatus from a first optical communication apparatus and a control signal for reception signal processing from a first quantum key distribution apparatus to a second quantum key distribution apparatus.

### INCORPORATION BY REFERENCE

This application is based upon and claims the benefit of priority from Japanese patent application No. 2024-190015, filed on Oct. 29, 2024, the disclosure of which is incorporated herein in its entirety by reference.

### TECHNICAL FIELD

The present disclosure relates to a communication apparatus, a communication method, and a communication system.

### BACKGROUND ART

There is known a technique of QKD over WDM for performing quantum key distribution (QKD) through an optical wavelength division multiplexing (WDM) link (e.g., see PTL 1).

### CITATION LIST

### Patent Literature

PTL 1: JP 2008-514119 A

### SUMMARY

Unfortunately, the technique described in PTL 1 may cause the quantum key distribution not to be appropriately performed through an optical wavelength division multiplexing link, for example.

In view of the above-described problem, it is an example object of the present disclosure to provide a technique capable of appropriately performing the quantum key distribution through the optical wavelength division multiplexing link.

A first example aspect according to the present disclosure provides a communication apparatus that communicates an optical signal based on an electrical signal obtained by multiplexing a first control signal addressed to a second optical communication apparatus from a first optical communication apparatus and a control signal for reception signal processing from a first quantum key distribution apparatus to a second quantum key distribution apparatus.

A second example aspect according to the present disclosure provides a communication method including communicating an optical signal based on an electrical signal obtained by multiplexing the first control signal addressed to the second optical communication apparatus from the first optical communication apparatus and the control signal for the reception signal processing from the first quantum key distribution apparatus to the second quantum key distribution apparatus.

A third example aspect according to the present disclosure provides a communication system including a first communication apparatus including the first optical communication apparatus and the first quantum key distribution apparatus, and a second communication apparatus including the second optical communication apparatus and the second quantum key distribution apparatus, in which the first communication apparatus multiplexes a first control signal addressed to the second optical communication apparatus from the first optical communication apparatus and a control signal for reception signal processing from the first quantum key distribution apparatus to the second quantum key distribution apparatus, and transmits an optical signal based on the multiplexed electrical signal from the first optical communication apparatus to the second optical communication apparatus.

According to one aspect, an example advantage is that quantum key distribution can be appropriately performed through an optical wavelength division multiplexing link.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a configuration of a communication system according to an example embodiment;

FIG. 2 is a diagram illustrating an example of a configuration of a communication apparatus according to an example embodiment;

FIG. 3 is a flowchart illustrating an example of processing of a communication apparatus according to an example embodiment; and

FIG. 4 is a diagram illustrating a hardware configuration example of an information processing apparatus according to an example embodiment.

### EXAMPLE EMBODIMENT

The principles of the present disclosure will be described with reference to several exemplary example embodiments. It is to be understood that the example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings. Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures to explain illustrative example embodiments are not necessarily mandatory, and some features or steps may be omitted. The order of the steps described in any of the drawings may be changed as appropriate.

### <System Configuration>

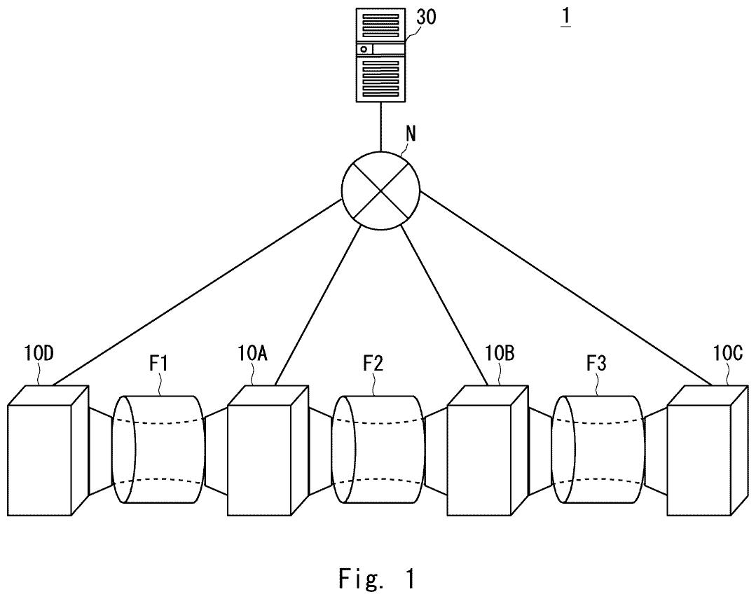

A configuration of a communication system 1 according to an example embodiment will be described with reference to FIG. 1. FIG. 1 is a diagram illustrating an example of a configuration of the communication system 1 according to the example embodiment. FIG. 1 illustrates the example in which the communication system 1 includes a communication apparatus 10A (an example of a “first communication apparatus”), a communication apparatus 10B (an example of a “second communication apparatus”), a communication apparatus 10C, a communication apparatus 10D (in a case where the communication apparatuses 10A to 10D do not need to be distinguished below, they are also simply referred to as “communication apparatuses 10”), and a server 30. The communication apparatuses 10 and the server 30 are each not limited in number to the number of the example of FIG. 1.

The example of FIG. 1 shows that the communication apparatuses 10 are each connected to the server 30 to be able to communicate with the server 30 through a network N for monitoring control. Examples of the network N include the Internet, a mobile communication system, a wireless local area network (LAN), a LAN, and a bus. Examples of the mobile communication system include a fifth generation mobile communication system (5G), a fourth generation mobile communication system (4G), a third generation mobile communication system (3G), and the like.

The communication apparatuses 10 are each connected to be able to communicate through optical communication networks F1 to F3 using optical fibers or the like. The communication apparatuses 10 each constitute a data communication network such as a backbone network, for example. The example of FIG. 1 shows that the communication apparatus 10D is connected to the communication apparatus 10A, the communication apparatus 10A is connected to the communication apparatus 10B and the communication apparatus 10D, and the communication apparatus 10B is connected to the communication apparatus 10A and the communication apparatus 10C.

### <Configuration of Communication Apparatus 10>

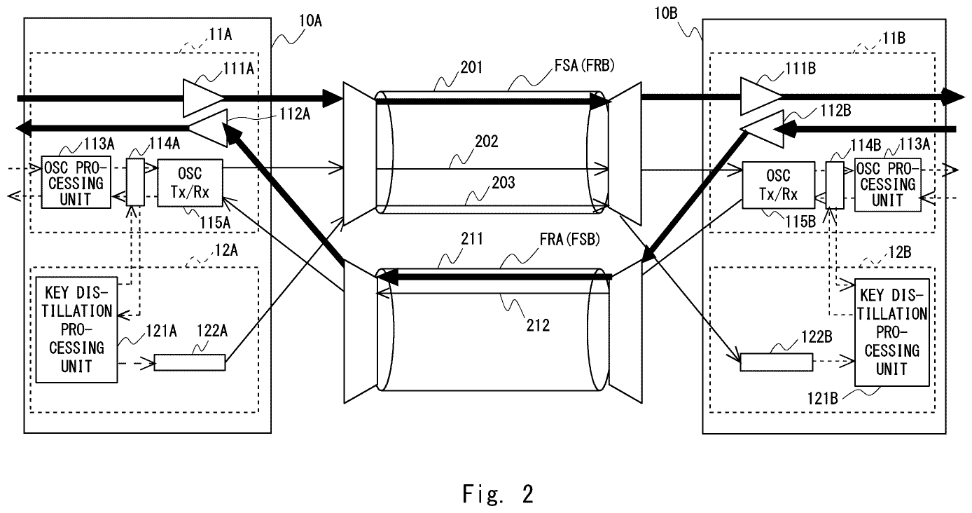

Next, a configuration of the communication apparatus 10 according to the example embodiment will be described with reference to FIG. 2. FIG. 2 is a diagram illustrating an example of the configuration of the communication apparatus 10 according to the example embodiment. The example of FIG. 2 shows that the communication apparatus 10A and the communication apparatus 10B are connected to each other by an optical fiber. The communication apparatus 10B is similar in configuration to the communication apparatus 10A.

The communication apparatus 10A includes an optical communication apparatus 11A and a quantum key distribution apparatus 12A. The communication apparatus 10A is connected to a transmission optical fiber FSA and a reception optical fiber FRA.

The optical communication apparatus 11A includes a transmission amplifier (AMP, amplifier) 111A, a reception amplifier 112A, an OSC processing unit 113A, a transfer unit 114A, and an OSC transmission/reception unit 115A. The transmission amplifier 111A amplifies an optical signal to be transmitted from the optical communication apparatus 11A to the other communication apparatus 10B at a data transmission wavelength (first wavelength) through the transmission optical fiber FSA. The transmission amplifier 111A transmits an optical signal 201 (upstream WDM optical signal, an optical signal for data communication) obtained by amplifying an optical signal from another communication apparatus (e.g., the communication apparatus 10D) to the other communication apparatus 10B through the transmission optical fiber FSA.

The reception amplifier 112A amplifies an optical signal received by the optical communication apparatus 11A from the other communication apparatus 10B at a data reception wavelength (fourth wavelength) through the reception optical fiber FRA. The reception amplifier 112A amplifies an optical signal 211 (downstream WDM optical signal) received from the other communication apparatus 10B through the reception optical fiber FRA and transmits the amplified signal to another communication apparatus (e.g., the communication apparatus 10D).

The OSC processing unit 113A processes information related to the optical signal for data communication using an optical supervisory channel (OSC), for example. The OSC processing unit 113A transmits and receives a packet (e.g., an IP packet or an Ethernet frame) to and from the OSC transmission/reception unit 115A through the transfer unit 114A as an electrical signal. The electrical signal may include an OSC control signal (first control signal). The first control signal in the electrical signal may include a control signal for loopback control of the transmission amplifier 111A that amplifies the optical signal transmitted by the optical communication apparatus 11A and the reception amplifier 112B that amplifies the optical signal for data communication received by an optical communication apparatus 11B. Consequently, output power or the like from the transmission amplifier 111A can be adjusted based on quality of the optical signal amplified by the reception amplifier 112B, for example. The OSC is a channel for remote monitoring control of an optical transmission apparatus (e.g., a relay optical amplifier and an optical node), and has functions defined by ITU-T G.692/G.807. The OSC is transmitted and received for each inter-relay optical amplifier section (optical transmission section (OTS)).

The transfer unit 114A receives a packet from the OSC transmission/reception unit 115A and transfers (transmits) the packet to the OSC processing unit 113A or a key distillation processing unit 121A based on information indicating a destination of the packet, for example. The transfer unit 114A also multiplexes the packet received from the OSC processing unit 113A and the packet that is an electrical signal received from the key distillation processing unit 121A, and transfers the multiplexed packet to the OSC transmission/reception unit 115A. The transfer unit 114A may be implemented by a layer 2 switch, for example.

The OSC transmission/reception unit (Tx/Rx) 115A converts the electrical signal received from the transfer unit 114A into an optical signal, and transmits the optical signal to the other communication apparatus 10B with an optical signal 202 at an OSC transmission wavelength (second wavelength) using the transmission optical fiber FSA. The OSC transmission/reception unit 115A converts the optical signal 212 into a packet (frame) of an electrical signal at an OSC reception wavelength (fifth wavelength) received from the other communication apparatus 10B using the reception optical fiber FRA, and outputs the packet to the transfer unit 114A.

The quantum key distribution apparatus 12A includes the key distillation processing unit 121A and a QKD communication instrument 122A. The QKD communication instrument 122A is a transmitter that transmits an optical signal (quantum optical signal) for quantum key distribution in which eavesdropping is detected using the principle of quantum mechanics in a case where key data is distributed using an optical signal 203 (quantum optical signal) at a wavelength (third wavelength) for QKD transmission, or a receiver that receives the optical signal. The QKD communication instrument 122A serving as the transmitter may transmit key data to a receiver by a BB84 method for transmitting the key data with information on a key of one bit recorded for each one photon, or a CV-QKD method for transmitting the key data with information on a key of one bit recorded for a phase difference between a weak optical wave and normal light, for example.

The key distillation processing unit 121A performs key distillation processing of excluding a bit having a possibility of eavesdropping and sharing a secure encryption key in the quantum key distribution. The key distillation processing unit 121A transmits and receives an electrical signal of a packet (e.g., an IP packet or an Ethernet frame) to and from the OSC transmission/reception unit 115A through the transfer unit 114A. The key distillation processing unit 121A transmits a control signal for QKD (second control signal) to be transmitted to the other communication apparatus 10B and a control signal for reception signal processing of a quantum channel (fifth control signal), for example, to the OSC transmission/reception unit 115A through the transfer unit 114A.

The key distillation processing unit 121A also receives a control signal for QKD (fourth control signal) received from the other communication apparatus 10B, for example, from the OSC transmission/reception unit 115A through the transfer unit 114A. The control signal for the QKD may include key distillation data. Examples of the key distillation data may include information necessary for performing basis collation, error correction, and confidentiality enhancement, which are bidirectionally communicated between a transmitter side and a receiver side.

The control signal for the reception signal processing of the quantum channel may include at least one of a clock signal, a bit position synchronization signal, and a bit error rate (BER) estimation signal, for example. The clock signal may be a clock signal used as a reference on the transmitter side. In a case where clock synchronization is required between the transmitter side and the receiver side in the key distillation processing, the clock signal used as a reference on the transmitter side may be transmitted to the receiver side.

The bit position synchronization signal may be a signal used on the receiver side to accurately extract a bit from a signal transmitted by the transmitter side, for example. The bit position synchronization signal may be a specific flag pattern added at the beginning and the end of data, for example. The bit error rate estimation signal may be data on a specific pattern shared in advance between the transmitter side and the receiver side to estimate a bit error rate, for example.

The communication apparatus 10B includes the optical communication apparatus 11B and a quantum key distribution apparatus 12B. The communication apparatus 10B is connected to a transmission optical fiber FSB and a reception optical fiber FRB. The communication apparatus 10B is similar in configuration to the communication apparatus 10A.

### <Processing>

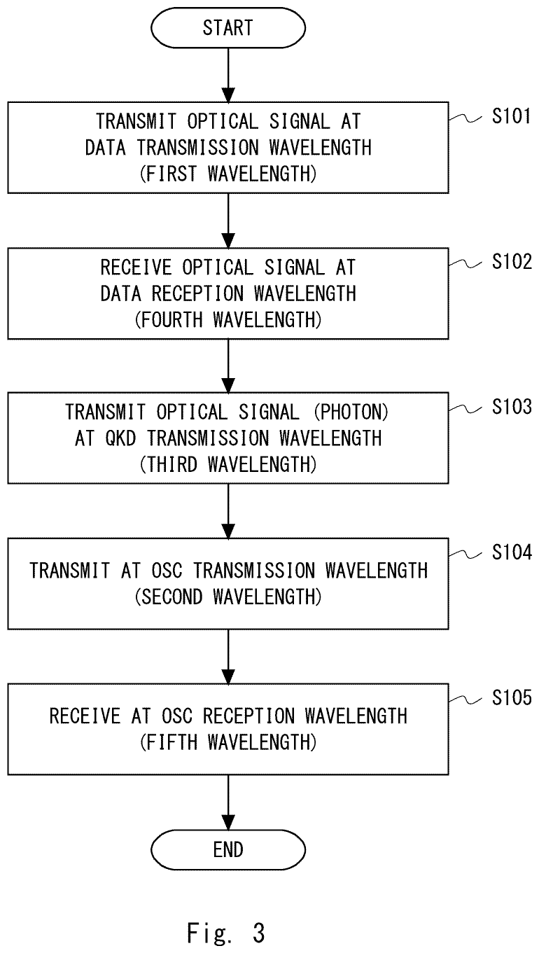

Next, an example of processing of the communication apparatus 10 according to the example embodiment will be described with reference to FIG. 3. FIG. 3 is a flowchart illustrating an example of the processing of the communication apparatus 10 according to the example embodiment. The order of the processing described below is an example for description, so that the processing may be performed in any order unless it is inconsistent. Hereinafter, an example will be described in which the QKD communication instrument 122A of the communication apparatus 10A is a transmitter and a QKD communication instrument 122B of the communication apparatus 10A is a receiver.

In step S101, the optical communication apparatus 11A transmits the optical signal 201 (upstream WDM optical signal) to the other optical communication apparatus 11B at the data transmission wavelength (first wavelength) using the transmission amplifier 111A and the transmission optical fiber FSA. Consequently, communication data having a relatively large size is transmitted from the communication apparatus 10A to the communication apparatus 10B.

Subsequently, the optical communication apparatus 11A receives the optical signal 211 (downstream WDM optical signal) from the other optical communication apparatus 11B at the data reception wavelength (fourth wavelength) using the reception amplifier 112A and the reception optical fiber FRA (step S102). Consequently, communication data having a relatively large size is transmitted from the communication apparatus 10B to the communication apparatus 10A.

Subsequently, the QKD communication instrument 122A transmits the optical signal 203 (quantum optical signal) for quantum key distribution to the QKD communication instrument 122B at the wavelength (third wavelength) for QKD transmission using the transmission optical fiber FSA (step S103).

Subsequently, the OSC transmission/reception unit 115A converts the electrical signal received from the transfer unit 114A into an optical signal, and transmits the optical signal 202 (upstream OSC optical signal) at the OSC transmission wavelength (second wavelength) to the other optical communication apparatus 11B using the transmission optical fiber FSA (step S104). Here, the transfer unit 114A may output an electrical signal of each of packets to the OSC transmission/reception unit 115A, the packets being obtained by multiplexing a packet of the first control signal received from the OSC processing unit 113A and packets of the second control signal and the fifth control signal received from the key distillation processing unit 121A. Then, the OSC transmission/reception unit 115A converts the electrical signal of each of the multiplexed packets received from the transfer unit 114A into an optical signal and transmits the optical signal.

### (Example of Preferentially Multiplexing OSC Control Signal (First Control Signal))

The transfer unit 114A may multiplex the first control signal in preference to the control signal (fifth control signal) for the reception signal processing. Consequently, delay and jitter (fluctuation) due to multiplexing can be reduced for the OSC control signal, for example. Thus, quality deterioration of data transmission by optical communication can be reduced.

The transfer unit 114A in this example may secure a specific band for a packet (frame) with a transmission source MAC address or an IP address belonging to the OSC processing unit 113A, for example. Then, in a case of receiving the packet, the transfer unit 114A may transfer the packet through a first queue for transmitting data in the specific band.

For example, the transfer unit 114A may transfer a packet with the transmission source MAC address or the IP address, which does not belong to the OSC processing unit 113A, through a second queue to which data is transferred in a case where the first queue is empty.

### (Example of Determining Priority of Multiplexing of Control Signal (Fifth Control Signal) for Reception Signal Processing Based on Data Size of Accumulated Quantum Keys)

The transfer unit 114A may determine the priority of multiplexing of the control signals for the reception signal processing based on data size of accumulated quantum keys. Consequently, the fifth control signal can be preferentially transmitted in accordance with the data size of the quantum key (final key) distributed and accumulated from the transmitter to the receiver, for example. The transfer unit 114A in this example may determine to give a higher multiplexing priority of the control signal for the reception signal processing as the data size of the accumulated quantum keys increases, for example. Consequently, a situation can be reduced in which waiting (standby time) occurs in decoding processing of data transmitted by optical communication due to no remaining amount of quantum keys, for example.

The transfer unit 114A in this example may multiplex the fifth control signal with the first priority in a case where the data size of the accumulated quantum keys is equal to or more than a threshold, for example. The transfer unit 114A also may multiplex the fifth control signal with the second priority higher than the first priority in a case where the data size of the accumulated quantum keys is not equal to or more than the threshold, for example. The first priority may be lower than a priority of at least one of the first control signal and the second control signal. The second priority may be equal to the priority of at least one of the first control signal and the second control signal. The transfer unit 114A in this example may statistically multiplex the fifth control signal and at least one of the first control signal and the second control signal, for example. The second priority may be higher than the priority of at least one of the first control signal and the second control signal. The transfer unit 114A in this example may secure a specific band for the fifth control signal, for example. The transfer unit 114A may receive information from the key distillation processing unit 121A, the information indicating the data size of the accumulated quantum keys or an instruction of priority control in accordance with the data size of the accumulated quantum keys.

### (Example of Multiplexing Control Signals for Reception Signal Processing in Preference to Key Distillation Data)

The transfer unit 114A may multiplex the control signal (fifth control signal) for the reception signal processing in preference to the second control signal (key distillation data). This example enables reducing a situation in which waiting (standby time) for the key distillation processing or signal missing occurs due to no reception of the control signal for the reception signal processing required for the key distillation processing, for example.

The transfer unit 114A in this example may preferentially transfer the fifth control signal using differentiated services (DiffServ), for example. The key distillation processing unit 121A in this example may add a value indicating the priority order to each packet (frame) of the fifth control signal and the second control signal and transmit the packet to the transfer unit 114A, for example. The value indicating the priority order may be a class of service (CoS) value that represents a priority of data in the layer 2, for example. Examples of the value indicating the priority may include a differentiated services code point (DSCP) value that represents a priority of data in a layer 3 and a precedence value.

Subsequently, the OSC transmission/reception unit 115A converts the optical signal 212 (downstream OSC optical signal) into an electrical signal, the optical signal 212 being received from the other optical communication apparatus 11B at the OSC reception wavelength (fifth wavelength) using the reception optical fiber FRA, and outputs the electrical signal to the transfer unit 114A (step S105). Here, the transfer unit 114A receives a packet from the OSC transmission/reception unit 115A and transfers the packet to the OSC processing unit 113A or a key distillation processing unit 121A based on information indicating a destination of the packet. The information indicating the destination of the packet may be an internet protocol (IP) address, a combination of an IP address and a port number, or a media access control (MAC) address, for example.

In a case of receiving the OSC control signal (third control signal) addressed to the OSC processing unit 113A from the optical communication apparatus 11B, the transfer unit 114A transfers the third control signal to the OSC processing unit 113A. Then, the OSC processing unit 113A performs control related to an optical signal for data communication based on the third control signal.

In a case of receiving the control signal (fourth control signal) addressed to the key distillation processing unit 121A from the optical communication apparatus 11B, the transfer unit 114A transfers the fourth control signal to the key distillation processing unit 121A. Then, the key distillation processing unit 121A performs key distillation processing of QKD based on the fourth control signal.

### (Example of Changing Wavelength)

The optical communication apparatus 11A may determine (set, change) a wavelength of another optical signal from the optical communication apparatus 11A to the optical communication apparatus 11B based on a wavelength of an optical signal used for data communication from the optical communication apparatus 11A to the optical communication apparatus 11B. This example enables using a wavelength at which deterioration in quality due to natural Raman scattering or the like is relatively reduced in accordance with availability of wavelengths used in data communication, for example.

The optical communication apparatus 11A in this example may determine the third wavelength of the optical signal 203 (quantum optical signal) used in the quantum channel from the quantum key distribution apparatus 12A to the quantum key distribution apparatus 12B based on the first wavelength used in the optical signal 201 (upstream WDM optical signal). The optical communication apparatus 11A also may determine the OSC transmission wavelength (second wavelength) to be used in transmission of the first control signal, the second control signal, and the fifth control signal based on the first wavelength.

### <Others>

In recent years, a system (QKD over WDM) for wavelength-multiplexing a QKD system in a fiber accommodating a general communication optical transmission system has been researched and developed to reduce cost required for laying a dedicated fiber for the QKD system. This system allows a QKD apparatus to be installed in an installation station of a WDM apparatus, and allows a WDM optical signal and a quantum optical signal to be wavelength-multiplexed by a WDM multiplexing/demultiplexing function and transmitted in the same fiber.

Five optical signals multiplexed at different wavelengths will be discussed, the five optical signals including a WDM optical signal for data communication (e.g., C-band 80 wavelength, at a wavelength of 1529 to 1564 nm), an OSC optical signal (e.g., at a wavelength of 1510 nm), a control signal for QKD (e.g., at a wavelength of 1565 nm), a quantum optical signal (e.g., at a wavelength of 1550 nm), and a control signal for reception signal processing of a quantum channel (e.g., at a wavelength of 1555 nm). An optical signal of a control signal for the reception signal processing of a quantum channel that is a QKD classical channel is generated by intensity modulation at low speed and is wavelength-multiplexed. This optical signal may be considered to cause a performance such as a key generation rate of the QKD to be degraded due to the natural Raman scattering caused by the optical signal of the control signal for the reception signal processing of the quantum channel. Additionally, the WDM optical signal for data communication may be considered to be degraded in quality due to a nonlinear optical effect in the optical fiber caused by the control signal for the reception signal processing of the quantum channel.

In contrast, the present disclosure causes the control signal for the reception signal processing of the quantum channel to be wavelength-multiplexed on an OSC optical signal and transmitted. Consequently, the quantum key distribution can be appropriately performed through the optical wavelength division multiplexing link, for example.

### <Hardware Configuration>

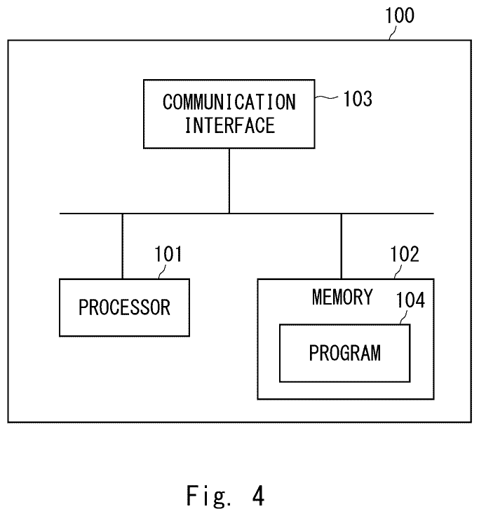

At least a part of the functions of the communication apparatus 10 according to the example embodiment may be implemented by cooperation of software and a computer as hardware. FIG. 4 is a diagram illustrating a hardware configuration example of a computer 100 provided in the communication apparatus 10 according to the example embodiment. FIG. 4 illustrates the example in which the computer 100 includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the cooperation of the processor 101, the memory 102, and the like, at least a part of processing according to the example embodiment of the present disclosure is performed by the computer 100. The memory 102 may be of any type. The memory 102 may be a non-transitory computer-readable storage medium, as a non-limiting example. The memory 102 may also be implemented using any suitable data storage technique such as a semiconductor-based memory apparatus, a magnetic memory apparatus and system, an optical memory apparatus and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may have a plurality of processors, such as an application specific integrated circuit chip that is temporally dependent on a clock that synchronizes the main processor.

Example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing apparatuses.

The present disclosure also provides at least one computer program product tangibly stored on a non-transitory computer-readable storage medium. The computer program product includes computer-executable instructions, such as those included in a program module, and is executed on an apparatus on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed apparatus. The distributed apparatus enables the program module to be disposed on both local and remote storage media.

Program codes for executing the methods of the present disclosure may be written in any combination of one or more programming languages. These program codes are provided to a processor or controller of a general purpose computer, a dedicated computer, or other programmable data processing apparatuses. In a case where the program codes are executed by the processor or controller, the functions/operations in the flowcharts and/or the implemented block diagrams are performed. The program codes are executed entirely on the machine, partly on the machine, as a stand-alone software package, partly on the machine, partly on a remote machine, or entirely on the remote machine or the server.

The programs each include a group of instructions (or software code) for causing the computer to perform one or more functions described in the example embodiments in a case where the programs are loaded into the computer. The programs may be stored in a non-transitory computer-readable medium or a tangible storage medium. Non-limiting examples of a computer-readable medium or tangible storage medium include a random-access memory (RAM), a read-only memory (ROM), a flash memory, a solid-state drive (SSD), other memory techniques, a compact disc read-only memory (CD-ROM), a digital versatile disc (DVD), a Blu-ray (registered trademark) disc, other optical disc storages, a magnetic cassette, a magnetic tape, a magnetic disk storage, and other magnetic storage apparatuses. The programs may be transmitted on a transitory computer-readable medium or a communication medium. Non-limiting examples of the transitory computer-readable medium or the communication medium include electrical, optical, and acoustic propagation signals, and propagation signals in other forms.

### <Modified Example>

Although the communication apparatus 10 may be provided in one housing, the communication apparatus 10 of the present disclosure is not limited thereto. Each unit of the communication apparatus 10 may be implemented by cloud computing including one or more computers, for example.

The optical communication apparatus 11A and the quantum key distribution apparatus 12A provided in the communication apparatus 10A may be each provided in a different housing, or may be each provided in the same housing. The optical communication apparatus 11B and the quantum key distribution apparatus 12B provided in the communication apparatus 10B may be each provided in a different housing, or may be each provided in the same housing. Communication apparatuses 10 as described above are also included in an example of the “communication apparatus” of the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Some or all of the above-described example embodiments may also be described as Supplementary Notes below, but are not limited to the Supplementary Notes. Some or all of the elements (such as a configuration and a function) described in each Supplementary Note dependent on Supplementary Note 1 can also be dependent on an independent Supplementary Note of another category in a similar dependency relationship. Some or all of the elements described in any Supplementary Note may be applied to various types of hardware, software, recording means for recording software, systems, and methods.

### (Supplementary Note 1)

A communication apparatus that communicates an optical signal based on an electrical signal obtained by multiplexing a first control signal addressed to a second optical communication apparatus from a first optical communication apparatus and a control signal for reception signal processing from a first quantum key distribution apparatus to a second quantum key distribution apparatus.

### (Supplementary Note 2)

The communication apparatus described in Supplementary Note 1, wherein the first control signal is multiplexed in preference to the control signal for the reception signal processing.

### (Supplementary Note 3)

The communication apparatus described in Supplementary Note 1 or 2, wherein the control signal for the reception signal processing includes at least one of a clock signal, a bit position synchronization signal, and a bit error rate estimation signal.

### (Supplementary Note 4)

The communication apparatus described in Supplementary Note 1 or 2, wherein
the first optical communication apparatus and the first quantum key distribution apparatus are provided, and
the optical signal is transmitted from the first optical communication apparatus to the second optical communication apparatus.

### (Supplementary Note 5)

The communication apparatus described in Supplementary Note 1 or 2, wherein a priority of multiplexing of the control signal for the reception signal processing is determined based on data size of accumulated quantum keys.

### (Supplementary Note 6)

The communication apparatus described in Supplementary Note 5, wherein
the control signal for the reception signal processing is multiplexed with a first priority in a case where a data size of the accumulated quantum keys is equal to or more than a threshold, and
the control signal for the reception signal processing is multiplexed with a second priority higher than the first priority in a case where the data size of the accumulated quantum keys is not equal to or more than the threshold.

### (Supplementary Note 7)

The communication apparatus described in Supplementary Note 1 or 2, wherein
the first control signal, the control signal for the reception signal processing, and key distillation data in quantum key distribution (QKD) from the first quantum key distribution apparatus to the second quantum key distribution apparatus are multiplexed; and
the control signal for the reception signal processing is multiplexed in preference to the key distillation data.

### (Supplementary Note 8)

The communication apparatus described in Supplementary Note 1 or 2, wherein
the second optical communication apparatus and the second quantum key distribution apparatus are provided, and
the second optical communication apparatus receives the optical signal from the first optical communication apparatus.

### (Supplementary Note 9)

A communication method including: communicating an optical signal based on an electrical signal obtained by multiplexing a first control signal addressed to a second optical communication apparatus from a first optical communication apparatus and a control signal for reception signal processing from a first quantum key distribution apparatus to a second quantum key distribution apparatus.

### (Supplementary Note 10)

A communication system including:
a first communication apparatus including a first optical communication apparatus and a first quantum key distribution apparatus; and
a second communication apparatus including a second optical communication apparatus and a second quantum key distribution apparatus, wherein
the first communication apparatus multiplexes a first control signal addressed to the second optical communication apparatus from the first optical communication apparatus and a control signal for reception signal processing from the first quantum key distribution apparatus to the second quantum key distribution apparatus, and
the first communication apparatus transmits an optical signal based on the multiplexed electrical signal from the first optical communication apparatus to the second optical communication apparatus.

### (Supplementary Note 11)

The communication method according to Supplementary Note 9, further comprising:
multiplexing the first control signal in preference to the control signal for the reception signal processing.

### (Supplementary Note 12)

The communication method according to Supplementary Note 9, wherein the control signal for the reception signal processing includes at least one of a clock signal, a bit position synchronization signal, and a bit error rate estimation signal.

### (Supplementary Note 13)

The communication method according to Supplementary Note 9, wherein
the first optical communication apparatus and the first quantum key distribution apparatus are provided, and
further comprising: transmitting the optical signal from the first optical communication apparatus to the second optical communication apparatus.

### (Supplementary Note 14)

The communication method according to Supplementary Note 9, further comprising:
determining a priority of multiplexing of the control signal for the reception signal processing based on data size of accumulated quantum keys.

### (Supplementary Note 15)

The communication method according to Supplementary Note 14, further comprising:
multiplexing the control signal for the reception signal processing with a first priority in a case where a data size of the accumulated quantum keys is equal to or more than a threshold, and
multiplexing the control signal for the reception signal processing with a second priority higher than the first priority in a case where the data size of the accumulated quantum keys is not equal to or more than the threshold.

### (Supplementary Note 16)

The communication method according to Supplementary Note 9, further comprising:
multiplexing the first control signal, the control signal for the reception signal processing, and key distillation data in quantum key distribution (QKD) from the first quantum key distribution apparatus to the second quantum key distribution apparatus; and
multiplexing the control signal for the reception signal processing in preference to the key distillation data.

### (Supplementary Note 17)

The communication method according to Supplementary Note 9, wherein
the second optical communication apparatus and the second quantum key distribution apparatus are provided, and
further comprising: causing the second optical communication apparatus to receive the optical signal from the first optical communication apparatus.

What is claimed is:

1. A communication apparatus comprising:
at least one memory storing an instruction; and
at least one processor configured to execute the instruction and coupled to the at least one memory,
the at least one processor being configured to communicate an optical signal based on an electrical signal obtained by multiplexing a first control signal addressed to a second optical communication apparatus from a first optical communication apparatus and a control signal for reception signal processing from a first quantum key distribution apparatus to a second quantum key distribution apparatus.

2. The communication apparatus according to claim 1, wherein the at least one processor is configured to multiplex the first control signal in preference to the control signal for the reception signal processing.

3. The communication apparatus according to claim 1, wherein the control signal for the reception signal processing includes at least one of a clock signal, a bit position synchronization signal, and a bit error rate estimation signal.

4. The communication apparatus according to claim 1, wherein
the first optical communication apparatus and the first quantum key distribution apparatus are provided, and
the at least one processor is configured to transmit the optical signal from the first optical communication apparatus to the second optical communication apparatus.

5. The communication apparatus according to claim 1, wherein the at least one processor is configured to determine a priority of multiplexing of the control signal for the reception signal processing based on data size of accumulated quantum keys.

6. The communication apparatus according to claim 5, wherein
the at least one processor is configured to multiplex the control signal for the reception signal processing with a first priority in a case where a data size of the accumulated quantum keys is equal to or more than a threshold, and
the at least one processor is configured to multiplex the control signal for the reception signal processing with a second priority higher than the first priority in a case where the data size of the accumulated quantum keys is not equal to or more than the threshold.

7. The communication apparatus according to claim 1, wherein
the at least one processor is configured to multiplex the first control signal, the control signal for the reception signal processing, and key distillation data in quantum key distribution (QKD) from the first quantum key distribution apparatus to the second quantum key distribution apparatus; and
the at least one processor is configured to multiplex the control signal for the reception signal processing in preference to the key distillation data.

8. The communication apparatus according to claim 1, wherein
the second optical communication apparatus and the second quantum key distribution apparatus are provided, and
the at least one processor is configured to cause the second optical communication apparatus to receive the optical signal from the first optical communication apparatus.

9. A communication method comprising: communicating an optical signal based on an electrical signal obtained by multiplexing a first control signal addressed to a second optical communication apparatus from a first optical communication apparatus and a control signal for reception signal processing from a first quantum key distribution apparatus to a second quantum key distribution apparatus.

10. A communication system comprising:
a first communication apparatus including a first optical communication apparatus and a first quantum key distribution apparatus; and
a second communication apparatus including a second optical communication apparatus and a second quantum key distribution apparatus,
the first communication apparatus including:
at least one memory storing an instruction; and
at least one processor configured to execute the instruction and coupled to the at least one memory,
the at least one processor being configured to multiplex a first control signal addressed to the second optical communication apparatus from the first optical communication apparatus and a control signal for reception signal processing from the first quantum key distribution apparatus to the second quantum key distribution apparatus, and
the at least one processor being configured to transmit an optical signal based on the multiplexed electrical signal from the first optical communication apparatus to the second optical communication apparatus.

11. The communication method according to claim 9, further comprising:
multiplexing the first control signal in preference to the control signal for the reception signal processing.

12. The communication method according to claim 9, wherein the control signal for the reception signal processing includes at least one of a clock signal, a bit position synchronization signal, and a bit error rate estimation signal.

13. The communication method according to claim 9, wherein
the first optical communication apparatus and the first quantum key distribution apparatus are provided, and
further comprising: transmitting the optical signal from the first optical communication apparatus to the second optical communication apparatus.

14. The communication method according to claim 9, further comprising:
determining a priority of multiplexing of the control signal for the reception signal processing based on data size of accumulated quantum keys.

15. The communication method according to claim 14, further comprising:
multiplexing the control signal for the reception signal processing with a first priority in a case where a data size of the accumulated quantum keys is equal to or more than a threshold, and
multiplexing the control signal for the reception signal processing with a second priority higher than the first priority in a case where the data size of the accumulated quantum keys is not equal to or more than the threshold.

16. The communication method according to claim 9, further comprising:
multiplexing the first control signal, the control signal for the reception signal processing, and key distillation data in quantum key distribution (QKD) from the first quantum key distribution apparatus to the second quantum key distribution apparatus; and
multiplexing the control signal for the reception signal processing in preference to the key distillation data.

17. The communication method according to claim 9, wherein
the second optical communication apparatus and the second quantum key distribution apparatus are provided, and
further comprising: causing the second optical communication apparatus to receive the optical signal from the first optical communication apparatus.
